(19) United States
(12) Patent Application Publication
(10) Pub. No.: US 2015/0233699 A1
(43) Pub. Date: Aug. 20, 2015

(54) THREE-DIMENSIONAL MEASURMENT DEVICE AND THREE-DIMENSIONAL MEASURMENT METHOD

(71) Applicant: Shun-Fu Technology Corp., Taipei City (TW)

(72) Inventor: Yung-Sheng HUANG, Taipei City (TW)

(21) Appl. No.: 14/610,769

(22) Filed: Jan. 30, 2015

(30) Foreign Application Priority Data
Feb. 19, 2014 (TW) 103105403

(51) Int. Cl. G01B 9/00

(52) U.S. Cl. CPC G01B 9/00

(57) ABSTRACT

A three dimensional measurement device includes a measurement device disposed in a space and rotatably projecting laser beam to the space to measure a plurality of points or surfaces so as to obtain data of the space; at least one processor processing the data of the space; and a display device connected to the processor.

### BACKGROUND OF THE INVENTION

1. Field of the Invention

The invention relates to a three dimensional measurement device and a three dimensional measurement method, wherein a measurement device is disposed in a predetermined position of a space to measure a plurality of points or surfaces so as to obtain data of the space, and the data is processed by a processor to display on a display device in a predetermined format by a graphic application.

2. Description of the Related Art

Conventionally, a spirit level is used to measure levelness. The spirit level includes a glass tube in which a bubble is sealed. Two marks are printed on the glass tube and spaced from two end of the glass tube by an equal distance.

By viewing the bubble position and estimating the distance between the bubble and the mark, it is determined whether the object is in a horizontal position. However, such a typical spirit level takes much time comparing the distances between two ends of the bubble and the marks, a user must have a good ability to compare the distances, and the result of each comparison is possibly different.

Although a laser level meter is used to replace the conventional spirit level, the laser level meter measures a predetermined point or a plurality points by rotating its laser beam, which can perform only two dimensional measurements.

### BRIEF SUMMARY OF THE INVENTION

An object of the invention is to provide a three dimensional measurement device and a three dimensional measurement method capable of performing three dimensional measurement through two dimensional measurement for measuring total area of an outdoor space.

Another object of the invention is to provide a three dimensional measurement device and a three dimensional measurement method capable of obtaining data of any position of the space by selecting a point on a display device.

The invention provides a three dimensional measurement device. The three dimensional measurement device in accordance with an exemplary embodiment of the invention includes a measurement device disposed in a space and rotatably projecting laser beam to the space to measure a plurality of points or surfaces so as to obtain data of the space; at least one processor processing the data of the space; and a display device connected to the processor.

In another exemplary embodiment, the display device is a display device of a mobile phone, a tablet, a laptop, a personal computer or a computational device.

In yet another exemplary embodiment, the processor comprises a calculating device calculating the data and a merging device merging the data.

In another exemplary embodiment, the processor processes the data and output the data in a graphic file format.

In yet another exemplary embodiment, the data in the graphic file format is edited by a graphic application.

In another exemplary embodiment, the data in the graphic file format is edited by a graphic application.

In yet another exemplary embodiment, the graphic application is AutoCAD, Pro-E or Solidwork.

In another exemplary embodiment, the measurement device is a laser level meter rotatably projecting laser beam.

The invention provides a three dimensional measurement method. The three dimensional measurement method in accordance with an exemplary embodiment of the invention includes: placing a measurement device rotatably projecting laser beams in a plurality of positions in a space to measure a plurality of points or surfaces so as to obtain data of the space; transmitting the data to at least one processor, and the processor processes the data to obtain three dimensional graphic data of every point and every surface of the space; connecting the three dimensional graphic data to a display device of an electronic device; and displaying a three dimensional graphic in the display device for selecting a position of the three dimensional graphic to show position data of the position.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of an embodiment of a three-dimensional measurement device of the invention;

FIG. 2 is a schematic view showing a three-dimensional measurement device disposed in a space for measuring the space;

FIG. 3 is a flow chart of an embodiment of a three-dimensional measurement method of the invention;

FIG. 4 depicts the three-dimensional measurement device of FIG. 2 performing measurement;

FIG. 5 is a schematic view of the space to be measured;

FIG. 6 depicts a three-dimensional measurement device of the invention disposed in a first position;

FIG. 7 depict a planar view of a space obtained from a three-dimensional measurement device of the invention shown in FIG. 6;

FIG. 8 depicts a three-dimensional measurement device of the invention disposed in a second position;

FIG. 9 depict a planar view of a space obtained by a three-dimensional measurement device of the invention shown in FIG. 8;

FIG. 10 is a perspective view of a space obtained from a three-dimensional measurement device of the invention shown in FIG. 6;

FIG. 11 is a perspective view of a space obtained from a three-dimensional measurement device of the invention shown in FIG. 8; and

FIG. 12 is a perspective view of the space superimposing the space of FIG. 10 and the space of FIG. 11.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

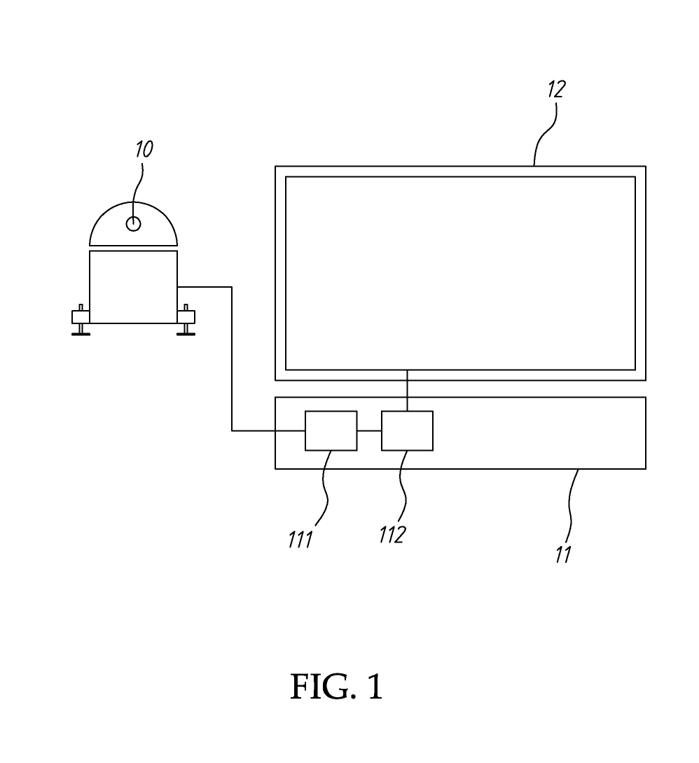

Referring to FIG. 1, an embodiment of a three dimensional measurement device of the invention includes at least one measurement device 10 which is a laser level meter capable of simultaneously rotating and projecting laser beams to measure a space so as to obtain data of the space. The data is transmitted to a processor 11, and the processor 11 is connected to a display device 12. The display device 12 can be a display device of a mobile phone, a tablet, a laptop, a personal computer or a computational device.

In an embodiment, the processor 11 includes a calculating device 111 calculating the data and a merging device 112 merging the data. The processor 11 loads related graphic applications into various electronic devices.

Referring to FIG. 2, the measurement device 10 is placed in a space 20 to be measured. The measurement device 10 measures a plurality of points and a plurality of surfaces of the space 20 to obtain data of the points and surfaces. By calculating or adding the data of the points and the surfaces, data of each point, each surface and even the space are obtained. In this embodiment, the space 20 includes a concave space 21.

When the space 20 is a regular-shaped space, such as a cubic space or a rectangular space, the measurement device 10 can obtain all of the data by laser measuring the space 20 once. When the space 20 is an irregular-shaped space, the measurement device 10 must measure the space 20 more than one time, and measured data are merged to obtain the data of the space 20.

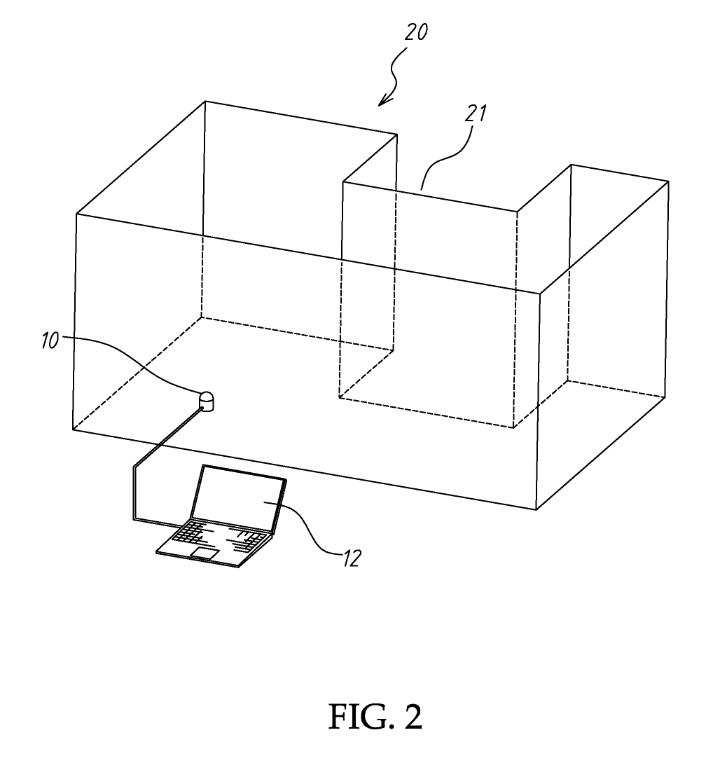

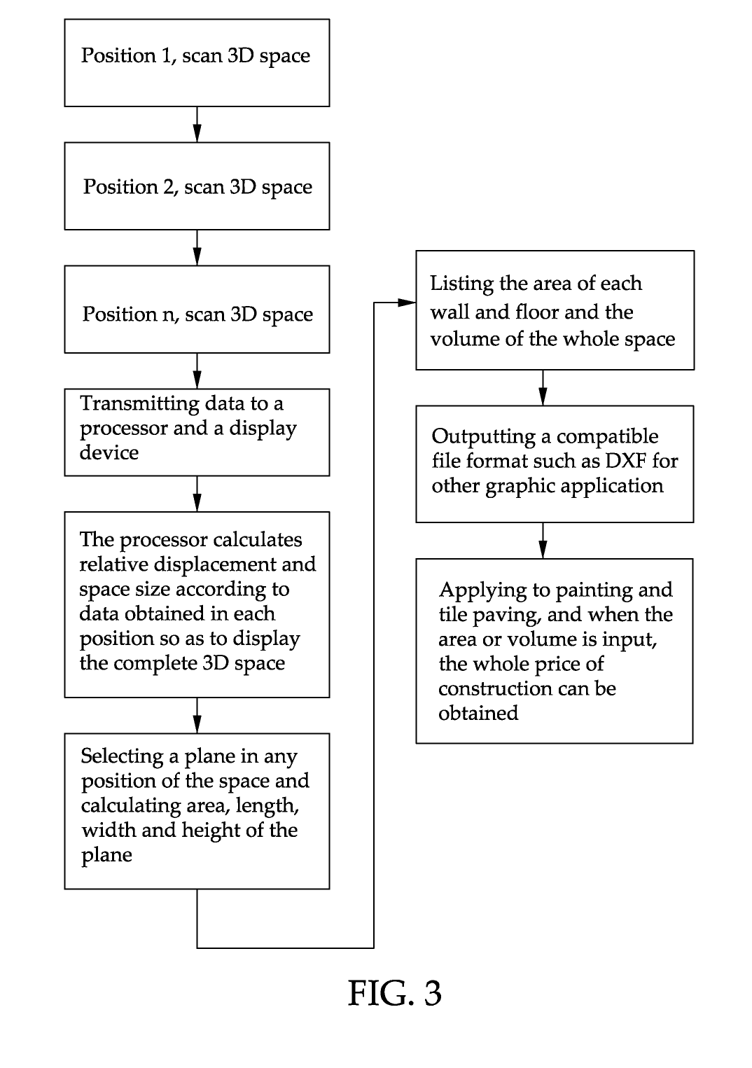

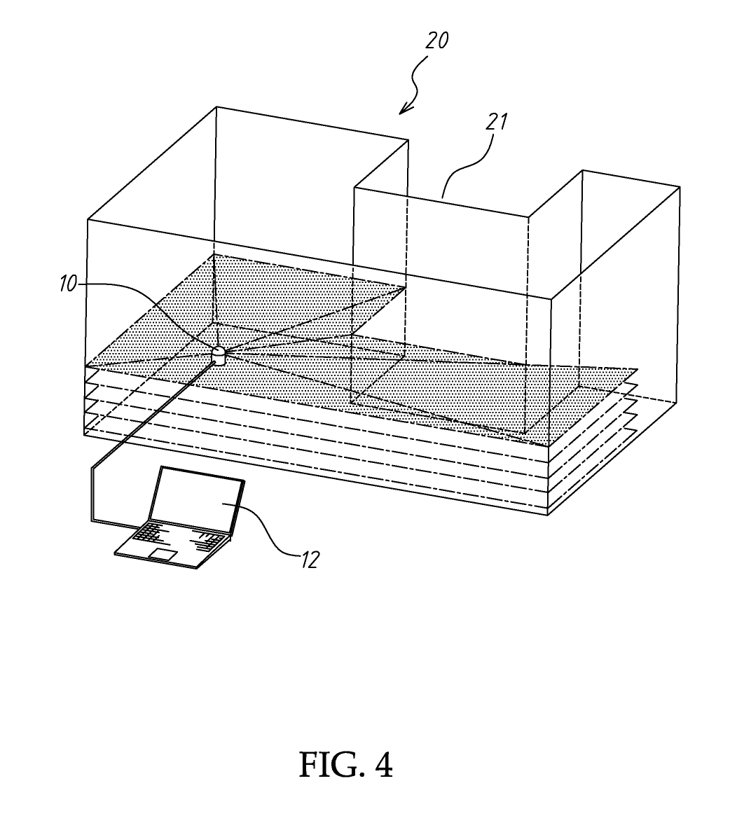

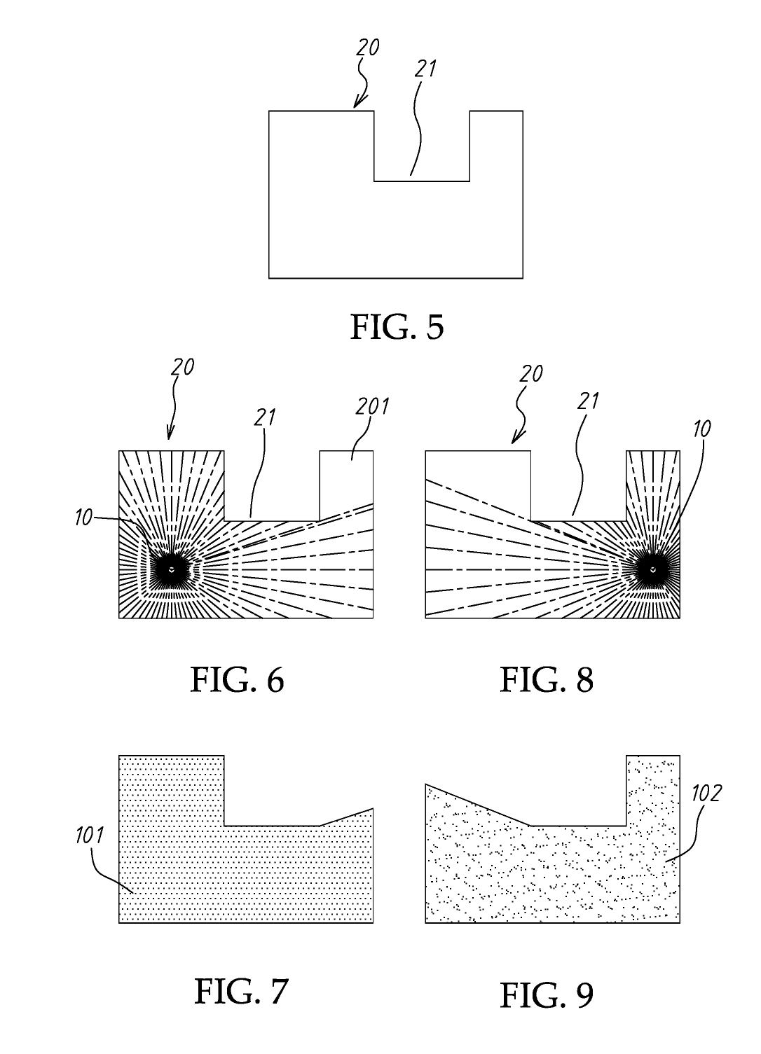

FIG. 3 shows the steps of three dimensional measurement method. FIGS. 4 to 12 shows operational process for measuring the irregular space 20.

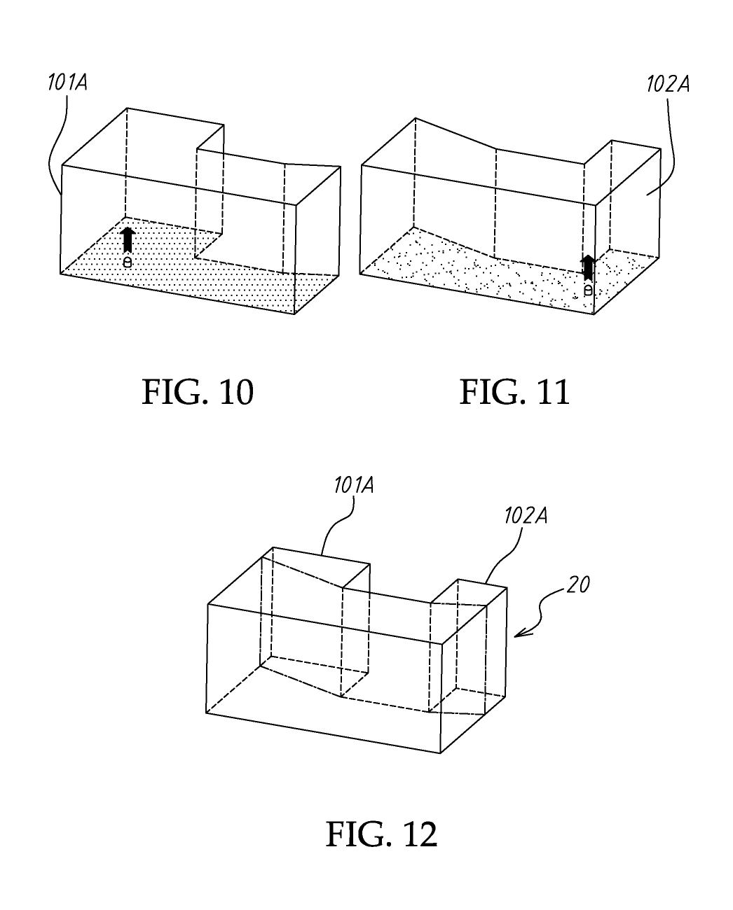

Referring to FIG. 4, the measurement device 10 is placed in a first position. In this embodiment, the first position is on one side of the concave space 21. The measurement device 10 scans and measures the space 20 point by point and surface by surface. The plane 101 scanned by the measurement device 10 is shown as FIG. 7. A plurality of planes 101 are superimposed to obtain a three dimensional graphic 101A shown as FIG. 10.

Because the space 20 has a dead corner 201 which cannot be scanned by laser beams when the measurement device 10 scans the space 20 in the first position. The measurement device 10 must be placed in a second position as shown in FIG. 8 (another side of the concave space 21) to scan the space 20 again, and the plane 102 scanned by the measurement device 10 is shown in FIG. 9. A plurality of planes 102 are superimposed to obtain a three dimensional graphic 102A shown as FIG. 11.

The measurement device 10 can performs laser measurement once (for regular shaped space) to obtain three dimensional data of an object (such as the space 20). In this embodiment, although the measurement device 10 performs laser measurement twice in two positions to obtain data of the space 20, the measurement device 10 can perform laser measurement more than twice in more than two positions to obtain data of the space 20.

As shown in FIG. 3, through laser scan at least one time, data of each point and each surface are obtained and transmitted to the processor 11 and the display device 12. The processor 11 calculate the data obtained in each position to obtain relative displacement and three dimensional size of the space 20, and the space 20 can be displayed by the display device 12. The data is processed by the processor 11 and output as a file in a predetermined file format (such as Auto CAD output file of DXF), and the file can be edited by graphic applications or viewed by graphic viewers.

Through some commercial graphic applications, such as Auto CAD, Pro-E or Solidworks, a user can select various positions and surfaces of the space 20 on the display device 12, and the size of any position, any wall or any floor of the space 20 can be calculated and displayed.

In an embodiment, the processor 11 and the display device 12 are built in the measurement device 10, and the measurement device 10 can edit and read measurement data directly.

The data obtained by the three dimensional device and the three dimensional method of the invention can be applied to painting or tile paving. When the area or volume is input, the whole price of construction can be obtained.

The three dimensional device and the three dimensional method of the invention uses measurement device to measure data of a space, and a user select any position on the display device to obtain data of the position of the space, whereby data of the space can be obtained quickly.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A three-dimensional measurement device, comprising:
a measurement device disposed in a space and rotatably projecting laser beam to the space to measure the space point by point and surface by surface so as to obtain data of the space;
at least one processor processing the data of the space; and
a display device connected to the processor.

2. The three-dimensional measurement device as claimed in claim 1, wherein the display device is a display device of a mobile phone, a tablet, a laptop, a personal computer or a computational device.

3. The three-dimensional measurement device as claimed in claim 1, wherein the processor comprises a calculating device calculating the data and a merging device merging the data.

4. The three-dimensional measurement device as claimed in claim 1, wherein the processor processes the data and output the data in a graphic file format.

5. The three-dimensional measurement device as claimed in claim 4, wherein the data in the graphic file format is edited by a graphic application.

6. The three-dimensional measurement device as claimed in claim 5, wherein the graphic application is AutoCAD, Pro-E or Solidwork.

7. The three-dimensional measurement device as claimed in claim 4, wherein the data in the graphic file format is read directly by the graphic application.

8. The three-dimensional measurement device as claimed in claim 1, wherein the measurement device is a laser level meter rotatably projecting laser beam.

9. The three-dimensional measurement device as claimed in claim 1, wherein the processor and the display device are built in the measurement device.

10. A three dimensional measurement method, comprising:
placing a measurement device rotatably projecting laser beams in a plurality of positions in a space to measure a plurality of points or surfaces so as to obtain data of the space;
transmitting the data to at least one processor, and the processor processes the data to obtain three dimensional graphic data of every point and every surface of the space;
connecting the three dimensional graphic data to a display device of an electronic device; and
displaying a three dimensional graphic in the display device for selecting a position of the three dimensional graphic to show position data of the position.

11. The three dimensional measurement method as claimed in claim 10, wherein the display device is a display device of a mobile phone, a tablet, a laptop, a personal computer or a computational device.

12. The three dimensional measurement method as claimed in claim 10, wherein the processor comprises a calculating device calculating the data and a merging device merging the data.

13. The three dimensional measurement method as claimed in claim 10, wherein the processor processes the data and output the data in a graphic file format.

14. The three dimensional measurement method as claimed in claim 13, wherein the data in the graphic file format is edited by a graphic application.

15. The three dimensional measurement method as claimed in claim 14, wherein the graphic application is AutoCAD, Pro-E or Solidwork.

16. The three dimensional measurement method as claimed in claim 13, wherein the data in the graphic file format is read directly by the graphic application.

17. The three dimensional measurement method as claimed in claim 10, wherein the measurement device is a laser level meter rotatably projecting laser beam.

18. The three dimensional measurement method as claimed in claim 10, wherein the processor and the display device are built in the measurement device.
